(19) United States
(12) Patent Application Publication
(10) Pub. No.: US 2025/0106283 A1
(43) Pub. Date: Mar. 27, 2025

(54) SYNCHRONIZATION ADMINISTRATION SYSTEM, INFORMATION PROCESSING DEVICE, ADMINISTRATIVE SERVER, NON-TRANSITORY COMPUTER READABLE MEDIUM STORING SYNCHRONIZATION ADMINISTRATION PROGRAM, NON-TRANSITORY COMPUTER READABLE MEDIUM STORING SYNCHRONIZATION PROGRAM FOR INFORMATION PROCESSING DEVICE, AND NON-TRANSITORY COMPUTER READABLE MEDIUM STORING SYNCHRONIZATION PROGRAM FOR ADMINISTRATIVE SERVER

(71) Applicant: FUJIFILM BUSINESS INNOVATION CORP., Tokyo (JP)

(72) Inventor: Koichi SATO, Kanagawa (JP)

(73) Assignee: FUJIFILM BUSINESS INNOVATION CORP., Tokyo (JP)

(21) Appl. No.: 18/581,878

(22) Filed: Feb. 20, 2024

(30) Foreign Application Priority Data
Sep. 21, 2023 (JP) 2023-156413

(51) Int. Cl. H04L 67/1095

(52) U.S. Cl. CPC H04L 67/1095

(57) ABSTRACT

A synchronization administration system includes: one or more first processors configured to: in a case where there is uncreated post-synchronous data that is unable to be provided to an information processing device from an administrative server at a first synchronization request timing at which the information processing device requests the administrative server to provide synchronous data, provide a synchronization necessity notification, which indicates that synchronization processing is necessary after the first synchronization request timing, from the administrative server to the information processing device; and provide the created post-synchronous data from the administrative server to the information processing device.

### CROSS-REFERENCE TO RELATED APPLICATIONS

This application is based on and claims priority under 35 USC 119 from Japanese Patent Application No. 2023-156413 filed Sep. 21, 2023.

### BACKGROUND

### (i) Technical Field

The present disclosure relates to a synchronization administration system, an information processing device, an administrative server, a non-transitory computer readable medium storing a synchronization administration program, a non-transitory computer readable medium storing a synchronization program for an information processing device, and a non-transitory computer readable medium storing a synchronization program for an administrative server.

### (ii) Related Art

JP2008-176436A discloses an administration device including: a receiving unit that receives a polling signal inquiring from at least one information processing device as to whether or not there is a transmission request to the information processing device via a firewall; and a transmitting unit that transmits a response to the polling signal received by the receiving unit in a state where the response includes an instruction to cause the information processing device to change the transmission interval of the polling signal.

### SUMMARY

Aspects of non-limiting embodiments of the present disclosure relate to a synchronization administration system, an information processing device, an administrative server, a non-transitory computer readable medium storing a synchronization administration program, a non-transitory computer readable medium storing a synchronization program for an information processing device, and a non-transitory computer readable medium storing a synchronization program for an administrative server that are capable of achieving prompt synchronization between data of an information processing device and data of an administrative server as compared with a case where synchronization is performed at a preset time such as at night or once a day on a relatively large amount of data or data that takes a long time to prepare for provision.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a synchronization administration system including: one or more first processors configured to: in a case where there is uncreated post-synchronous data that is unable to be provided to an information processing device from an administrative server at a first synchronization request timing at which the information processing device requests the administrative server to provide synchronous data, provide a synchronization necessity notification, which indicates that synchronization processing is necessary after the first synchronization request timing, from the administrative server to the information processing device; and provide the created post-synchronous data from the administrative server to the information processing device.

### BRIEF DESCRIPTION OF THE DRAWINGS

Exemplary embodiment(s) of the present invention will be described in detail based on the following figures, wherein:

FIG. 1 is a block diagram showing a configuration of a synchronization administration system according to an exemplary embodiment of the present disclosure;

FIG. 2 is a block diagram showing an administrative server of the synchronization administration system according to the present exemplary embodiment;

FIG. 3 is a block diagram showing an information processing device of the synchronization administration system according to the present exemplary embodiment;

FIG. 4 is a flowchart showing an example of synchronization administration processing executed by a first processor in the synchronization administration system according to the present exemplary embodiment;

FIG. 5 is a flowchart showing an example of synchronization administration processing executed by a second processor in the synchronization administration system according to the present exemplary embodiment;

FIG. 6 is a sequence diagram showing an example of the synchronization administration processing executed in the synchronization administration system according to the present exemplary embodiment;

FIG. 7 is a sequence diagram showing an example of synchronization administration processing executed in a synchronization administration system according to a first modification example; and

FIG. 8 is a sequence diagram showing an example of synchronization administration processing executed in a synchronization administration system according to a second modification example.

### DETAILED DESCRIPTION

Hereinafter, exemplary embodiments of the present disclosure will be described in detail with reference to the accompanying drawings. It should be noted that the identical reference numerals may be assigned to substantially the identical components and the identical processing, and repeated description may not be given. Further, unless otherwise specified in the specification, the number of each component is not limited to one, and a plurality of each component may be present.

### Present Exemplary Embodiment

### Synchronization Administration System

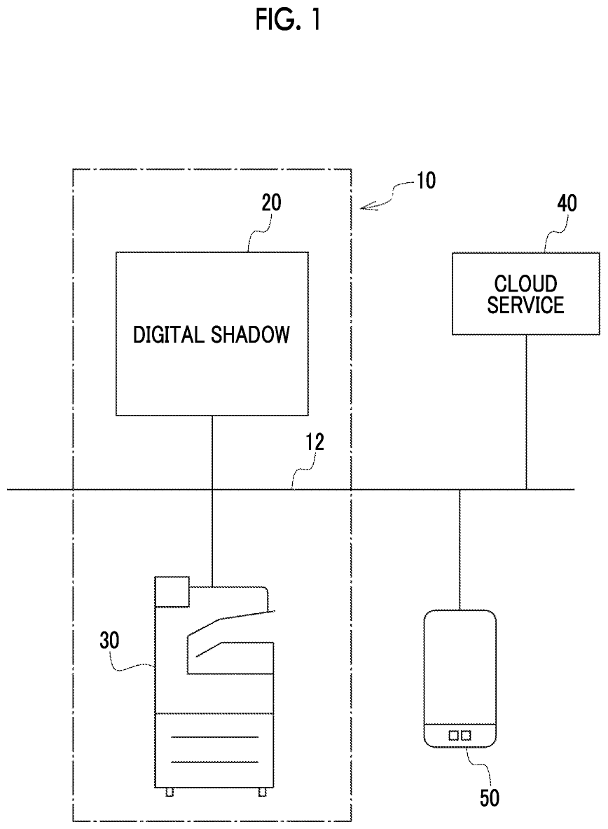

First, an example of a synchronization administration system 10 according to the present exemplary embodiment will be described with reference to FIGS. 1 to 3. As shown in FIG. 1, the synchronization administration system 10 using the information processing system according to the present exemplary embodiment is configured to include an administrative server 20 as an example of the information processing system and an information processing device 30 as an example of a physical actual device. The administrative server 20 and the information processing device 30 are each connected to the Internet 12 as an example of a communication line. It should be noted that the term “system” in the present exemplary embodiment includes both a system constituted by a plurality of apparatuses and a system constituted by a single apparatus.

### Administrative Server

The administrative server 20 as an example of the information processing system is a virtual device as an example of the physical actual device provided in the cloud server. The administrative server 20 of the present exemplary embodiment synchronizes with attribute data as synchronous data of the information processing device 30 of the actual device, thereby reflecting a state of the information processing device 30 as an example of a virtual device (also called “digital shadow”).

One or more cloud services 40 are connected to the administrative server 20 via the Internet 12. FIG. 1 shows a case where one cloud service 40 is connected, but in the present disclosure, a plurality of cloud services can be connected to each other. Further, a terminal device 50 of a user is connected to the administrative server 20 via the Internet 12. The cloud service includes, for example, a printing service in a remote operation using the terminal device 50 and a device administration service of the information processing device 30.

The terminal device 50 of the present exemplary embodiment is a mobile information device operated by a user who uses the information processing device 30 of the synchronization administration system 10. Specifically, the terminal device 50 is an information device, such as a laptop computer, a smartphone, a tablet terminal, and a wearable terminal, having a data input/output function, a data processing function, a communication function, and the like. The terminal device 50 may be an information device such as a stationary personal computer in which a place of use is stationary in advance. The terminal device 50 is connected to the plurality of cloud services 40 via the Internet 12.

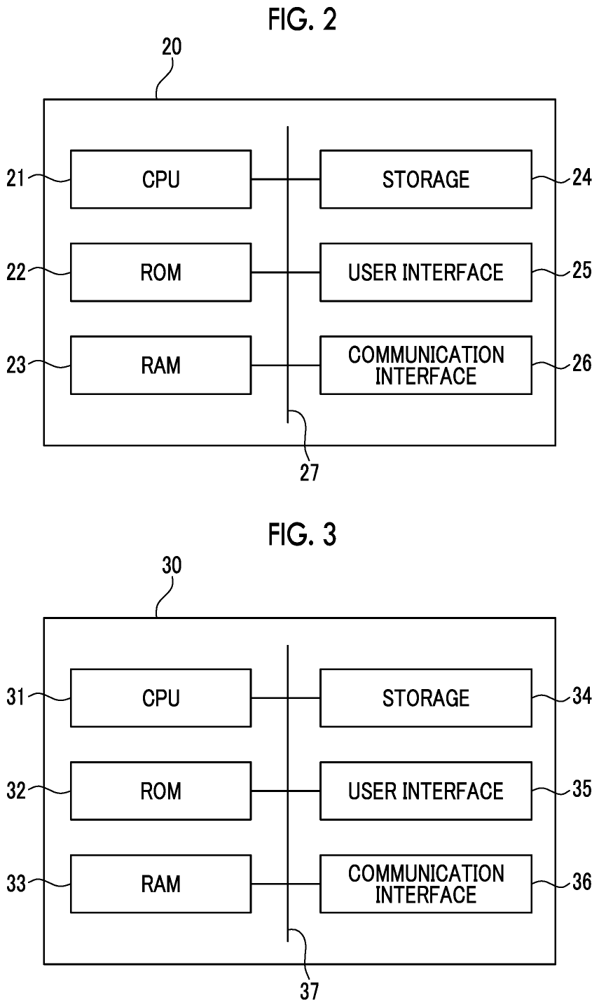

As shown in FIG. 2, the administrative server 20 has a central processing unit (CPU: processor) 21, a read only memory (ROM) 22, a random access memory (RAM) 23, a storage 24, a user interface 25, and a communication interface 26. The components are communicably connected to each other via a bus 27.

The CPU 21 is a central arithmetic processing unit and executes various programs or controls each unit. That is, the CPU 21 reads a program from the ROM 22 or the storage 24, and executes the program using the RAM 23 as a work area. The CPU 21 controls each of the above components and executes various kinds of arithmetic processing, according to the program recorded in the ROM 22 or the storage 24. The CPU 21 is an example of the first processor of the present disclosure. The administrative server 20 has at least one first processor.

In the present exemplary embodiment, the ROM 22 or the storage 24 stores the synchronization administration program for the administrative server. The synchronization administration program for the administrative server constitutes a synchronization administration program that is an arithmetic program for administering synchronization between the administrative server 20 and the information processing device 30.

The ROM 22 stores various programs and various data. The RAM 23 temporarily stores a program or data as a work area. The storage 24 is configured with a hard disk drive (HDD) or a solid state drive (SSD), and stores various programs and various types of data including an operating system.

The user interface 25 is an interface for the user to use the administrative server 20. The user interface 25 may include, for example, at least one of a liquid crystal display including a touch panel that enables a touch operation by the user, a voice input accepting section that accepts voice input by the user, a button that can be pressed by the user, or the like. The user interface 25 is an example of a display section of the present exemplary embodiment. It should be noted that the user interface 25 is not always necessary.

The communication interface 26 is an interface for the administrative server 20 to communicate with other devices. For example, standards such as Ethernet (registered trademark), FDDI, and Wi-Fi (registered trademark) are used.

In a case of executing the synchronization administration program for the administrative server, the administrative server 20 implements various functions by using the above-mentioned hardware resources. As functional configurations implemented by the administrative server 20, the administrative server 20 has a determination section, a providing section, and a creation section. Each functional configuration is implemented by the CPU 21 reading and executing a synchronization administration program for the administrative server stored in the ROM 22 or the storage 24.

### Information Processing Device

The information processing device 30 is a so-called digital multifunction device having an image forming device, an image scanner, and the like in the present exemplary embodiment. Specifically, the information processing device 30 is a device that performs data processing or the like relating to an image in accordance with an instruction of a user. It should be noted that examples of the data processing on an image include a scan function of reading the contents described on a recording medium such as paper as image data and a copy function of reproducing the contents of the image data of paper acquired by the scan function as an image on a recording medium as it is. Further, the data processing relating to an image includes a printing function of forming image data designated in advance by the user as an image on a paper medium.

In the present exemplary embodiment, basic functions of the information processing device 30, such as a copy function, are processed in the information processing device 30. The administrative server 20 processes an extended function of access to the outside via the Internet 12. In the present disclosure, the information processing device is not limited to the digital multifunction device and is optional.

As shown in FIG. 3, the information processing device 30 has a central processing unit (CPU: processor) 31, a read only memory (ROM) 32, a random access memory (RAM) 33, a storage 34, a user interface 35, and a communication interface 36. The components are communicably connected to each other via a bus 37.

The CPU 31 is a central arithmetic processing unit that executes various programs and controls each unit. That is, the CPU 31 reads a program from the ROM 32 or the storage 34, and executes the program by using the RAM 33 as a work area. The CPU 31 controls the respective components and performs various types of arithmetic processing in accordance with the programs recorded in the ROM 32 or the storage 34. The CPU 31 is an example of the second processor of the present disclosure. The information processing device 30 has at least one second processor.

In the present exemplary embodiment, the ROM 32 or the storage 34 stores the synchronization administration program for the information processing device. The synchronization administration program for an information processing device constitutes a synchronization administration program that is an arithmetic program for administering synchronization between the administrative server 20 and the information processing device 30.

The ROM 32 stores various programs and various kinds of data. The RAM 33 temporarily stores a program or data as the work area. The storage 34 is constituted by a hard disk drive (HDD) or a solid state drive (SSD), and stores various programs including an operating system and various data.

The user interface 35 is an interface for the user to use the information processing device 30. The user interface 35 may include, for example, at least one of a liquid crystal display including a touch panel that enables a touch operation by the user, a voice input accepting section that accepts voice input by the user, a button that can be pressed by the user, or the like. The user interface 35 is an example of a display section of the present exemplary embodiment. It should be noted that the user interface 35 is not always necessary.

The communication interface 36 is an interface for the information processing device 30 to communicate with other devices, and for example, a standard such as Ethernet (registered trademark), FDDI, or Wi-Fi (registered trademark) is used.

In a case of executing the synchronization administration program for the information processing device, the information processing device 30 implements various functions by using the above-mentioned hardware resources. As functional configurations implemented by the information processing device 30, the information processing device 30 has a determination section, a request section, and a synchronization section. Each functional configuration is implemented by the CPU 31 reading and executing the synchronization administration program for the information processing device stored in the ROM 32 or the storage 34.

In the present exemplary embodiment, the synchronization administration program for the administrative server using the administrative server 20 and the synchronization administration program for the information processing device using the information processing device 30 are executed in cooperation with each other. Thereby, the synchronization administration program using the synchronization administration system 10 is executed.

### Synchronization Administration Processing

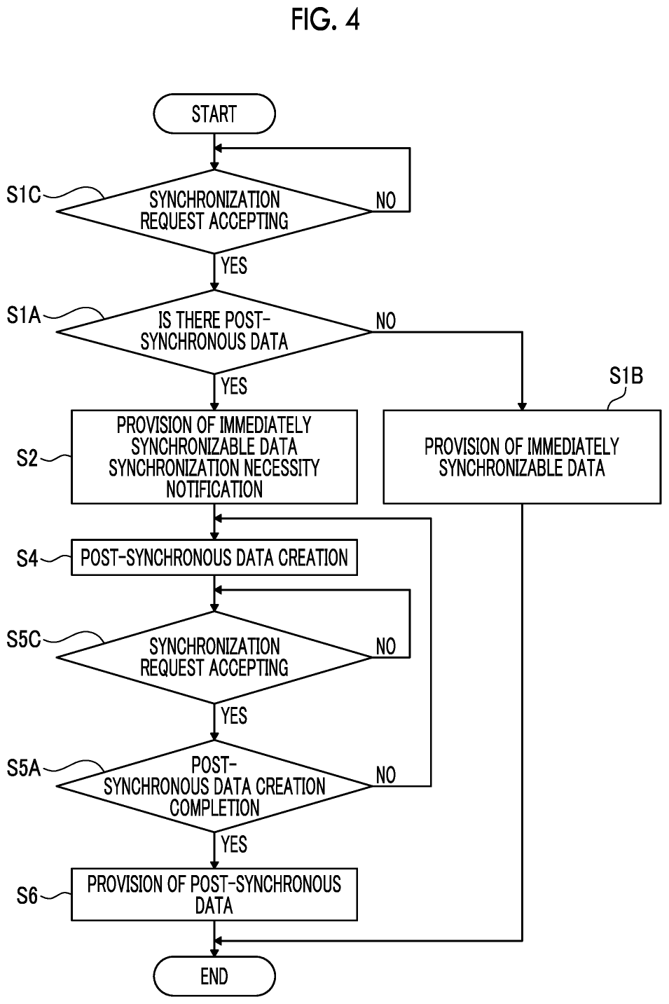

Next, an example of the synchronization administration processing executed in the synchronization administration system 10 according to the present exemplary embodiment will be described with reference to FIGS. 4 to 6.

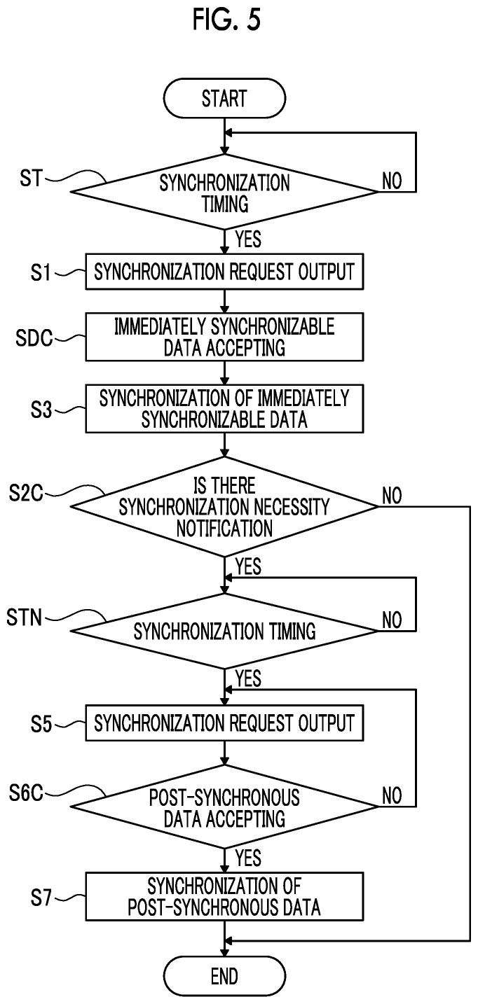

First, as shown in step ST in FIG. 5, the determination section of the information processing device 30 determines whether or not a first synchronization request timing Tl has been reached as the synchronization request timing. In a case where the first synchronization request timing Tl is not reached, processing of step ST is repeated. In contrast, in a case where the first synchronization request timing T1 has been reached, as shown in step S1, at the first synchronization request timing T1, the request section of the information processing device 30 requests provision of the synchronous data to the administrative server 20, for example, by outputting the preset information.

Next, the determination section of the administrative server 20 determines whether or not to accept the synchronization request from the information processing device 30 in step S1C in FIG. 4. In a case where the synchronization request is not accepted, the processing of step S1C is repeated. In contrast, in a case where the synchronization request is accepted, the determination section of the administrative server 20 determines in step S1A whether or not there is uncreated post-synchronous data that is unable to be provided from the administrative server 20 to the information processing device 30.

In a case where the post-synchronous data does not exist in step S1A, the providing section of the administrative server 20 provides only the immediately synchronizable data to the information processing device 30 in step S1B. As shown in step SDC in FIG. 5, the synchronization section of the information processing device 30 accepts only the immediately synchronizable data and receives the data. The synchronization section of the information processing device 30 synchronizes the immediately synchronizable data provided in step S3 in FIG. 5. Then, the administrative server 20 and the information processing device 30 end the processing.

In the present specification, the phrase “providing synchronous data or post-synchronous data from the administrative server to the information processing device” is defined to include both a state where the administrative server directly transmits the synchronous data or the post-synchronous data to the information processing device, and a state where the synchronous data is transmitted using information (for example, a URL) indicated by a storage destination on the network in which the synchronous data or the post-synchronous data is stored.

On the other hand, in step S1A, at the first synchronization request timing T1, in a case where there is uncreated post-synchronous data that is unable to be provided from the administrative server 20 to the information processing device 30, the processing of the administrative server 20 proceeds to step S2 of the synchronization administration processing according to the present exemplary embodiment in FIG. 4. In step S2, the providing section of the administrative server 20 provides immediately synchronizable data and a synchronization necessity notification from the administrative server 20 to the information processing device 30. As shown in step SDC in FIG. 5, the synchronization section of the information processing device 30 accepts the immediately synchronizable data by receiving the data.

The synchronization necessity notification is a notification which indicates that the synchronization processing is necessary after the first synchronization request timing T1. In the present disclosure, it is not always necessary to provide both the immediately synchronizable data and the synchronization necessity notification. In a case where there is no immediately synchronizable data, only the synchronization necessity notification may be provided.

In the present disclosure, the processing of providing the synchronization necessity notification to the information processing device 30 through the administrative server 20 includes both a case where there is a synchronization request from the information processing device 30 and a case where there is no synchronization request from the information processing device 30. The case where there is no synchronization request from the information processing device 30 includes, for example, a case where the information processing device 30 fetches the post-synchronous data from a designated location at a timing different from the synchronization timing.

Next, the synchronization section of the information processing device 30 synchronizes the immediately synchronizable data provided in step S3 in FIG. 5. Further, the creation section of the administrative server 20 creates the post-synchronous data in step S4 in FIG. 4.

Next, as shown in step S2C in FIG. 5, the determination section of the information processing device 30 determines whether or not the synchronization necessity notification has been received. In a case where the synchronization necessity notification is not received, the processing ends. In contrast, in a case where the synchronization necessity notification is received, the processing proceeds to step STN in FIG. 5.

Next, as shown in step STN, after the first synchronization request timing T1, the determination section of the information processing device 30 determines whether or not the second synchronization request timing T2, which comes next to the first synchronization request timing T1, has been reached as the synchronization request timing. In a case where the second synchronization request timing T2 is not reached, the processing of step STN is repeated.

In contrast, in a case where the second synchronization request timing T2 has been reached, as shown in step S5, the request section of the information processing device 30 requests the provision of the synchronous data at the second synchronization request timing T2. The second synchronization request timing T2 of the present exemplary embodiment is an example of periodic synchronization timings that may include not only synchronization of post-synchronous data but also synchronization of other synchronous data.

Next, the determination section of the administrative server 20 determines whether or not to accept the synchronization request from the information processing device 30 in step S5C in FIG. 4. In a case where the synchronization request is not accepted, the processing of step S5C is repeated. In contrast, in a case where the synchronization request is accepted, in step S5A in FIG. 4, the determination section of the administrative server 20 determines whether or not there is uncreated post-synchronous data that is unable to be provided from the administrative server 20 to the information processing device 30. That is, at the second synchronization request timing T2, it is determined whether or not the creation of the post-synchronous data is completed.

In a case where the creation of the post-synchronous data is completed, as shown in step S6 in FIG. 4, the providing section of the administrative server 20 provides the created post-synchronous data from the administrative server 20 to the information processing device 30, at the second synchronization request timing T2. As shown in step S6C in FIG. 5, the information processing device 30 determines whether or not the post-synchronous data is accepted by receiving the data. In a case where the post-synchronous data is not accepted, the processing proceeds to step S5.

In contrast, in a case where the post-synchronous data is accepted, the synchronization section of the information processing device 30 synchronizes the post-synchronous data provided in step S7 in FIG. 5. In the present exemplary embodiment, the synchronization section of the information processing device 30 synchronizes the post-synchronous data provided from the administrative server 20 with the synchronous data of the information processing device 30, in a period of time which is preset in accordance with the number of users of the information processing device 30.

In addition, in the present disclosure, the period of time, during which the CPU 31 of the second processor synchronizes the post-synchronous data provided from the administrative server 20 with the synchronous data of the information processing device 30, is not limited to the period of time which is preset in accordance with the number of users of the information processing device 30. Thus, any period of time may be adopted. For example, the period of time may be determined as a period of time which is preset from the viewpoint of power consumption, or may be determined as a combination of a period of time which is preset in accordance with the number of users of the information processing device 30 and a period of time which is preset from the viewpoint of power consumption.

### Type of Synchronous Data

Here, the synchronous data has a plurality of types. Specifically, for example, history data of work performed by the information processing device 30, equipment state data such as an input state of a power source or a state during work or hibernation, setting information for setting a work state of the information processing device 30, and machine information such as the remaining amount of paper or toner cartridge.

In the present exemplary embodiment, the CPU 31 of the second processor assigns priority orders for determining an execution order of the synchronization processing in the information processing device 30 to a plurality of synchronous data pieces in accordance with the type. Further, the orders of synchronization of the plurality of synchronous data pieces are determined in accordance with the respective priority orders, and synchronization is executed in the information processing device 30.

In the present disclosure, the CPU 21 of the first processor may assign the priority orders. The assignment of the priority orders may be executed, for example, by the user using the CPU 21 of the first processor or the CPU 31 of the second processor. Further, the CPU 21 of the first processor or the CPU 31 of the second processor may assign priority orders on the basis of preset conditions. It should be noted that, in the present disclosure, the assignment of priority orders is not always necessary.

### Third Synchronization Request Timing

On the other hand, in step S5A in FIG. 4, there is a case where the creation of the post-synchronous data is not completed at the second synchronization request timing T2, that is, there is a case where the post-synchronous data is unable to be provided from the administrative server 20 to the information processing device 30. In a case where the administrative server 20 is unable to provide the post-synchronous data at the second synchronization request timing T2, the processing of the administrative server 20 proceeds to step S4 in FIG. 4, and the administrative server 20 continues to create the post-synchronous data.

Further, the processing of the information processing device 30 proceeds to step S5 in FIG. 5, and the request section of the information processing device 30 requests the provision of the synchronous data, at the third synchronization request timing T3 which comes next to the second synchronization request timing T2, after the second synchronization request timing T2, in step S5.

Then, in step S5A in FIG. 4, the determination section of the administrative server 20 determines again whether or not there is uncreated post-synchronous data that is unable to be provided from the administrative server 20 to the information processing device 30. In a case where there is the post-synchronous data, in step S6 in FIG. 4, the providing section of the administrative server 20 provides the created post-synchronous data at the third synchronization request timing T3 from the administrative server 20 to the information processing device 30.

As shown in step S6C in FIG. 5, the information processing device 30 accepts the post-synchronous data by receiving the data. Then, the synchronization section of the information processing device 30 synchronizes the provided post-synchronous data in step S7 in FIG. 5. In a case where the creation of the post-synchronous data is not completed at the third synchronization request timing T3, the processing of steps S5A to S6 in FIG. 4 and the processing of step S7 in FIG. 5 are repeated until the creation of the post-synchronous data is completed.

Here, in the present exemplary embodiment, the first synchronization request timing T1, the second synchronization request timing T2, and the third synchronization request timing T3 at which the information processing device 30 requests the provision of the synchronous data are periodic. In the present exemplary embodiment, in a case where the synchronization necessity notification is provided to the information processing device 30 in step S2, the CPU 31 of the second processor sets the intervals between adjacent synchronization request timings in a plurality of periodic synchronization request timings such that the intervals are shorter than an interval before the synchronization necessity notification is provided. It should be noted that, in the present disclosure, the plurality of synchronization request timings at which the information processing device 30 requests the provision of the synchronous data may be irregular.

It should be noted that, in the present disclosure, in a case where the CPU 21 of the first processor is unable to provide the post-synchronous data from the administrative server 20 to the information processing device 30 at the second synchronization request timing T2, the CPU 21 of the first processor provides the post-synchronous data. This configuration is not limited to the provision at the third synchronization request timing T3. For example, in a case where the CPU 21 of the first processor is unable to provide the post-synchronous data from the administrative server 20 to the information processing device 30 at the second synchronization request timing T2, the CPU 21 may execute polling for the administrative server 20 on the information processing device 30, until a timing at which the administrative server 20 is able to provide the post-synchronous data.

### Action of Present Exemplary Embodiment

In the present exemplary embodiment, at the first synchronization request timing T1, in a case where there is uncreated post-synchronous data that is unable to be provided to the information processing device 30 from the administrative server 20, the CPU 21 of the first processor provides a synchronization necessity notification, which indicates that the synchronization processing is necessary after the first synchronization request timing T1, from administrative server 20 to the information processing device 30. Therefore, it is possible to achieve prompt synchronization between the data of the information processing device 30 and the data of the administrative server 20 as compared with a case where the synchronization is performed at a preset time such as at night or once a day on a relatively large amount of data or data that takes a long time to prepare for provision.

Further, in the present exemplary embodiment, the CPU 21 of the first processor provides the created post-synchronous data at the second synchronization request timing T2 from the administrative server 20 to the information processing device 30. Therefore, even in a case where the post-synchronous data is unable to be provided at the first synchronization request timing T1, the post-synchronous data is able to be provided again at the second synchronization request timing T2.

Further, in the present exemplary embodiment, in a case where the CPU 21 of the first processor is unable to provide the post-synchronous data from the administrative server 20 to the information processing device 30 at the second synchronization request timing T2, the CPU 21 provides the created post-synchronous data, at the third synchronization request timing T3 at which the information processing device 30 requests the provision of the synchronous data, after the second synchronization request timing T2. Therefore, even in a case where the post-synchronous data is unable to be provided at the second synchronization request timing T2, the post-synchronous data is able to be provided again at the third synchronization request timing T3.

Further, in the present exemplary embodiment, in a case where the CPU 21 of the first processor is unable to provide the post-synchronous data from the administrative server 20 to the information processing device 30 at the second synchronization request timing T2, the CPU 21 is able to execute polling for the administrative server 20 on the information processing device 30, until a timing at which the administrative server 20 is able to provide the post-synchronous data. Therefore, it is not necessary to set the third synchronization request timing T3.

The term “execute polling” means that the administrative server 20 issues a polling command to the information processing device 30. Further, the term “execute polling” may include a state in which the information processing device 30 is allowed to voluntarily execute polling, regardless of the command.

Further, in the present exemplary embodiment, the CPU 31 of the second processor synchronizes the post-synchronous data provided from the administrative server 20 with the synchronous data of the information processing device 30, in a period of time which is preset in accordance with the number of users of the information processing device 30. Therefore, for example, by executing the synchronization processing in a period of time in which the number of users is relatively small, it is possible to reduce a time in which the use of the information processing device 30 is restricted. Therefore, in the present exemplary embodiment, it is easy to ensure the synchronization processing, as compared with a case where the period of time in which the synchronization processing is executed is random.

Further, in the present exemplary embodiment, priority orders for determining the execution order of the synchronization processing in the information processing device 30 are assigned to the plurality of synchronous data pieces in accordance with the type. Therefore, as compared with a case where the synchronization processing of the plurality of synchronous data pieces is sequentially executed regardless of the type in the order of provision, the synchronization processing having a high necessity may be prioritized over the synchronization processing having a low necessity.

Further, in the present exemplary embodiment, the first synchronization request timing T1, the second synchronization request timing T2, and the third synchronization request timing T3 at which the information processing device 30 requests the provision of the synchronous data are periodic. Further, in a case where the synchronization necessity notification is provided to the information processing device 30, the CPU 31 of the second processor sets interval between the plurality of periodic synchronization request timings shorter than the interval before the synchronization necessity notification is provided. Therefore, the post-synchronous data is able to be quickly provided as compared with a case where the interval between the plurality of periodic synchronization request timings do not change from the interval before the synchronization necessity notification is provided.

### First Modification Example

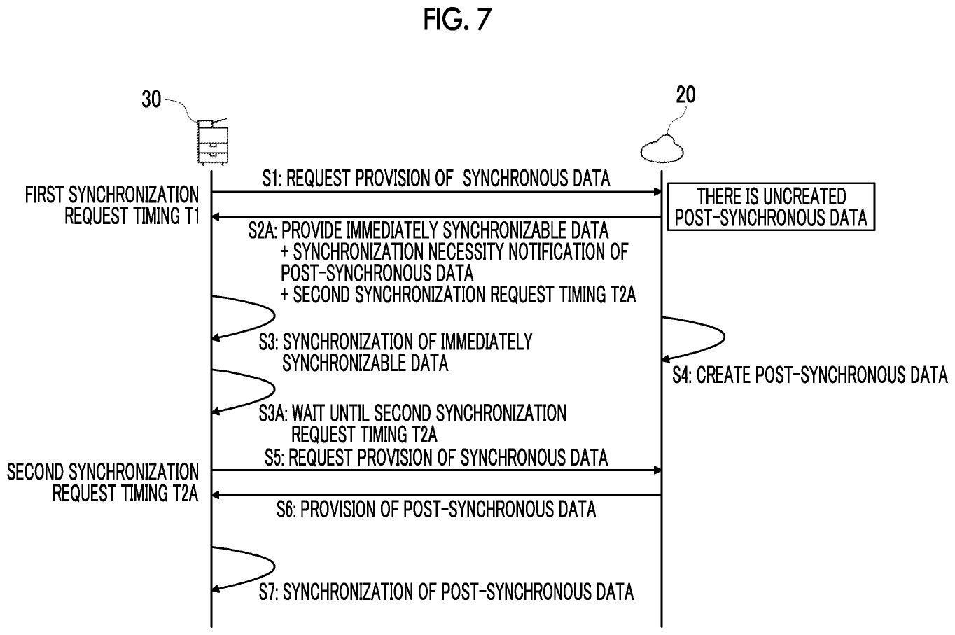

Next, a configuration of the synchronization administration system 10 according to the first modification example will be described with reference to FIG. 7. It should be noted that the identical reference numerals are assigned to the parts configured identically to the present exemplary embodiment, and the description thereof will not be given as appropriate.

### Synchronization Administration System

In the first modification example, the information processing device 30 further includes a standby section as a functional configuration implemented by the synchronization administration system 10. Since the other configurations in the first modification example are common to the corresponding configurations in the present exemplary embodiment, repeated description will not be given.

### Synchronization Administration Processing

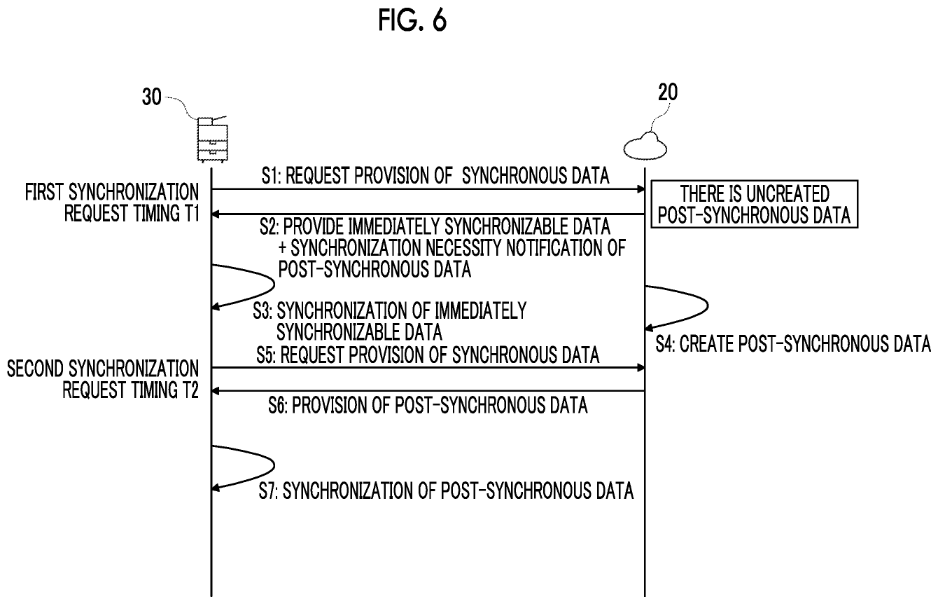

As shown in FIG. 7, the synchronization administration processing according to the first modification example is mostly different from the synchronization administration processing according to the present exemplary embodiment exemplified in FIG. 6 in that a second synchronization request timing T2A is provided in step S2A executed by the CPU 21 of the first processor. Further, the synchronization administration processing according to the first modification example is mostly different from the synchronization administration processing according to the present exemplary embodiment exemplified in FIG. 6 in that, in step S3A, the information processing device 30 waits for the synchronization request until the provided second synchronization request timing T2A, regardless of the periodic synchronization request timing.

Specifically, in step S2A, the providing section of the administrative server 20 provides the immediately synchronizable data, the synchronization necessity notification indicating that the synchronization processing is necessary after the first synchronization request timing T1, and the second synchronization request timing T2A, from the administrative server 20 to the information processing device 30. The second synchronization request timing T2A of the first modification example is an example of an irregular synchronization timing which is set exclusively for synchronization of the post-synchronous data.

In the first modification example, the CPU 21 of the first processor determines the second synchronization request timing T2A in accordance with the usage status of the administrative server 20 or the size of the post-synchronous data. Specifically, for example, in a case where another processing that is prioritized over the provision of the post-synchronous data is scheduled as the usage status of the administrative server 20, the second synchronization request timing T2A can be determined after the separate processing is completed.

In the present disclosure, the second synchronization request timing T2 may be determined in accordance with both the usage status of the administrative server 20 and the size of the post-synchronous data. That is, the CPU 21 of the first processor separately calculates the second synchronization request timing T2 in accordance with each parameter of the usage status of the administrative server 20 and the size of the post-synchronous data. Then, the CPU 21 of the first processor can be configured to employ the second synchronization request timing T2 that comes later out of the two calculated second synchronization request timings T2.

### Action of First Modification Example

Also in the first modification example, as in the present exemplary embodiment, it is possible to achieve prompt synchronization between the data of the information processing device 30 and the data of the administrative server 20 as compared with a case where the synchronization is performed at a preset time such as at night or once a day on a relatively large amount of data or data that takes a long time to prepare for provision.

Further, in the first modification example, as compared with a case where the second synchronization request timing T2A is randomly determined in time, for example, an amount of unnecessary communication may be reduced. Therefore, it is easy to ensure the synchronization processing. Other actions of the first modification example are the same as the operations in the case of the present exemplary embodiment.

### Second Modification Example

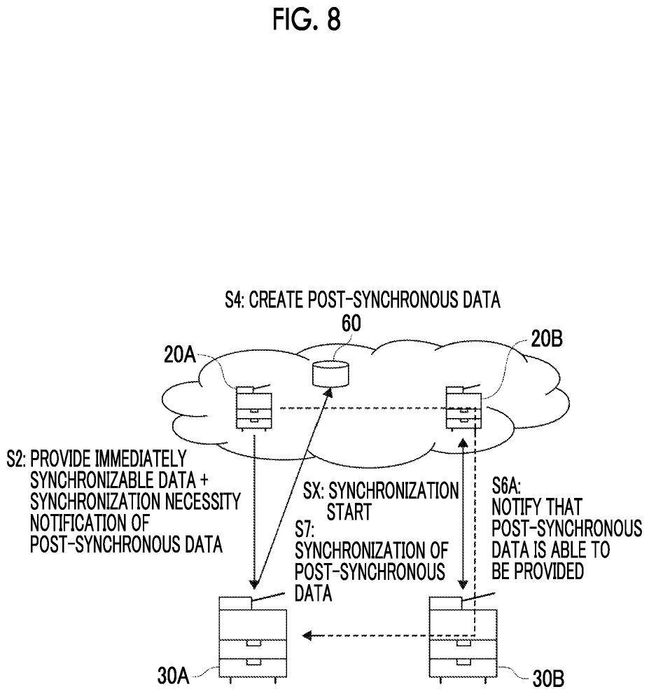

Next, a configuration of the synchronization administration system 10 according to the second modification example will be described with reference to FIG. 8. It should be noted that the identical reference numerals are assigned to the parts configured identically to the present exemplary embodiment, and the description thereof will not be given as appropriate.

### Synchronization Administration System

The synchronization administration system 10 in the second modification example is different from the synchronization administration system 10 according to the present exemplary embodiment exemplified in FIG. 1 in that, as the functional configurations implemented by the synchronization administration system 10, there are provided a first administrative server 20A, a first information processing device 30A corresponding to the first administrative server 20A, a second administrative server 20B, and a second information processing device 30B corresponding to the second administrative server 20B.

The first administrative server 20A and the second administrative server 20B each have the same configuration as the administrative server 20 in FIG. 1, and are administrative servers 20 different from each other. The first administrative server 20A and the second administrative server 20B are connected to each other via a network such as the Internet 12. The first information processing device 30A and the second information processing device 30B each have the same configuration as the information processing device 30 in FIG. 1, but are information processing device 30 different from each other. The first information processing device 30A and the second information processing device 30B are connected to each other via a network.

Further, in the second modification example, as the functional configuration implemented by the synchronization administration system 10, the second information processing device 30B further has a notification section that issues a notification that the post-synchronous data is able to be provided. Since other configurations in the second modification example are common to the corresponding configurations in the present exemplary embodiment, repeated description will not be given.

### Synchronization Administration Processing

In the synchronization administration processing according to the second modification example is mostly different from the synchronization administration processing according to the present exemplary embodiment in that it is indirectly notified via the second information processing device 30B that it is possible to provide the post-synchronous data to the first information processing device 30A, without a direct notification from the first administrative server 20A. FIG. 8 shows an exemplary case of employing a communication method using another second information processing device 30B different from the first information processing device 30A as a method of issuing the notification that the CPU 21 of the first processor of the first administrative server 20A is able to provide the post-synchronous data to the first information processing device 30A.

Specifically, after the data creation of the first administrative server 20A creates the post-synchronous data in step S4, the first administrative server 20A stores the post-synchronous data 60 in a region which is set on, for example, the Internet 12. Next, the providing section of the first administrative server 20A requests the second administrative server 20B to notify the second information processing device 30B of information indicating that the post-synchronous data is able to be provided to the first information processing device 30A.

Next, in step SX, the second administrative server 20B and the second information processing device 30B synchronize with each other. At the time of synchronization, the second information processing device 30B acquires information indicating that the first administrative server 20A is able to provide the post-synchronous data to the first information processing device 30A. The acquired information can be notified from the second information processing device 30B to the first information processing device 30A, for example, through wireless communication or the like. Then, in step S7, the first information processing device 30A accesses the post-synchronous data 60 via the Internet 12 and executes synchronization of the post-synchronous data 60.

That is, in the second modification example, another second information processing device 30B, which is likely to start data synchronization next, is used instead of the first information processing device 30A. For example, it is conceivable that both the synchronization interval between the first administrative server 20A and the first information processing device 30A and the synchronization interval between the second administrative server 20B and the second information processing device 30B are 10 minutes and there is a difference of 5 minutes for each between the synchronization timings. In the second modification example, the post-synchronous data is created by the first administrative server 20A after the provision of the synchronization necessity notification and before the synchronization timing of synchronization between the second administrative server 20B and the second information processing device 30B. In such a case, the first information processing device 30A is able to synchronize the post-synchronous data earlier than the periodic synchronization timing.

The second modification example has exemplified, as a method of issuing the notification that the post-synchronous data is able to be provided, a communication method using a second information processing device 30B different from the first information processing device 30A. However, in the present disclosure, the method of issuing the notification that the post-synchronous data is able to be provided is not limited thereto. The present disclosure may use at least one communication method among a communication method using e-mail, a communication method using the mobile communication line, and a communication method using the second information processing device 30B different from the first information processing device 30A.

As an example of the communication method using the mobile communication line, for example, LPWAN (low power wide area network) can be employed. The mobile communication line is an example of a communication method other than the communication method via the LAN and the Internet, such as the communication method using E-mail.

### Action of Second Modification Example

Also in the second modification example, as in the present exemplary embodiment, it is possible to achieve prompt synchronization between the data of the information processing device 30 and the data of the administrative server 20 as compared with a case where the synchronization is performed at a preset time such as at night or once a day on a relatively large amount of data or data that takes a long time to prepare for provision.

Further, in the second modification example, the information processing device 30 can be notified that the post-synchronous data is able to be provided at an optional timing after the creation of the post-synchronous data is completed. Therefore, in a case where the post-synchronous data is provided at the periodic synchronization request timing, the post-synchronous data is able to be provided without waiting for the coming of the next synchronization request timing. Other operations of the second modification example are the same as the operations in the case of the present exemplary embodiment.

### Other Exemplary Embodiments

The present disclosure is not limited to the exemplary embodiments described above, and various modifications, changes, and improvements can be made within a range without deviating from the gist of the present disclosure. For example, the exemplary embodiments described above and the modification examples may be appropriately configured and a plurality of combinations thereof may be configured.

Further, for example, in the present disclosure, in the above-mentioned exemplary embodiment, various processors other than the CPU may execute the synchronization administration processing for the administrative server or the synchronization administration processing for the information processing device, which are executed by each CPU reading software (program).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

More specifically, the hardware structure of these various processors is an electric circuit in which circuit elements such as semiconductor elements are combined.

Further, in each of the exemplary embodiments described above, the aspect in which the synchronization administration program is stored (installed) in advance in the ROM or the storage is described, but the present disclosure is not limited thereto. The program may be provided in a form of being recorded on a recording medium such as a compact disk read only memory (CD-ROM), a digital versatile disk read only memory (DVD-ROM), and a universal serial bus (USB) memory. Also, the program may be downloaded from an external device via a network.

The present disclosure includes various exemplary embodiments and the like that are not described above, and the technical scope of the present disclosure is defined only by the matters specifying the invention within the scope of claims appropriate from the above description.

### SUPPLEMENTARY NOTES

(((1)))

A synchronization administration system comprising:
one or more first processors configured to:
   in a case where there is uncreated post-synchronous data that is unable to be provided to an information processing device from an administrative server at a first synchronization request timing at which the information processing device requests the administrative server to provide synchronous data,
   provide a synchronization necessity notification, which indicates that synchronization processing is necessary after the first synchronization request timing, from the administrative server to the information processing device; and
   provide the created post-synchronous data from the administrative server to the information processing device.
(((2)))

The synchronization administration system according to (((1))), wherein the first processors are configured to:
provide the created post-synchronous data from the administrative server to the information processing device, at a second synchronization request timing at which the information processing device requests provision of the synchronous data, after the first synchronization request timing.
(((3)))

The synchronization administration system according to (((2))), wherein the first processors are configured to:
determine the second synchronization request timing in accordance with a usage status of the administrative server or a size of the post-synchronous data.
(((4)))

The synchronization administration system according to (((2))) or (((3))), wherein the first processors are configured to:
in a case where the post-synchronous data is unable to be provided from the administrative server to the information processing device at the second synchronization request timing,
provide the created post-synchronous data, at a third synchronization request timing at which the information processing device requests the provision of the synchronous data, after the second synchronization request timing.
(((5)))

The synchronization administration system according to any one of (((2))) to (((4))), wherein the first processors are configured to:
in a case where the post-synchronous data is unable to be provided from the administrative server to the information processing device at the second synchronization request timing,
cause the information processing device to execute polling on the administrative server until a timing at which the administrative server is able to provide the post-synchronous data.
(((6)))

The synchronization administration system according to any one of (((1))) to (((5))), further comprising:
one or more second processors configured to:
   synchronize the post-synchronous data provided from the administrative server with the synchronous data of the information processing device in a period of time which is preset in accordance with the number of users of the information processing device.
(((7)))

The synchronization administration system according to (((6))),
wherein the second processor assigns a priority order for determining an execution order of the synchronization processing in the information processing device to each of a plurality of pieces of the synchronous data in accordance with a type of the synchronous data.
(((8)))

The synchronization administration system according to (((6))) or (((7))),
wherein a plurality of synchronization request timings, at which the information processing device requests the provision of the synchronous data, are periodic, and
the second processors are configured to:
   in a case where the synchronization necessity notification is provided to the information processing device,
   set a periodic interval between the plurality of synchronization request timings shorter than a periodic interval before the synchronization necessity notification is provided.
(((9)))

The synchronization administration system according to any one of (((1))) to (((8))), wherein the first processors are configured to:
in a case where the post-synchronous data is created,
issue, to the information processing device, a notification that the post-synchronous data is able to be provided by using at least one communication method among a communication method using e-mail, a communication method using a mobile communication line, and a communication method using an information processing device different from the information processing device.
(((10)))

An administrative server comprising:
one or more first processors configured to:
   in a case where there is uncreated post-synchronous data that is unable to be provided to an information processing device at a first synchronization request timing at which the information processing device requests provision of the synchronous data,
   provide a synchronization necessity notification, which indicates that synchronization processing is necessary after the first synchronization request timing, to the information processing device; and
   provide the created post-synchronous data to the information processing device.
(((11)))

An information processing device comprising:
one or more second processors configured to:
   in a case where there is uncreated post-synchronous data that is unable to be provided to the information processing device from an administrative server at a first synchronization request timing at which the administrative server is requested to provide the synchronous data,
   synchronize the post-synchronous data provided from the administrative server after the first synchronization request timing with the synchronous data of the information processing device.
(((12)))

A synchronization administration program causing a computer to execute a process comprising:
in a case where there is uncreated post-synchronous data that is unable to be provided to an information processing device from an administrative server at a first synchronization request timing at which the information processing device requests the administrative server to provide synchronous data,
providing a synchronization necessity notification, which indicates synchronization processing is necessary after the first synchronization request timing, from the administrative server to the information processing device; and
providing the created post-synchronous data from the administrative server to the information processing device.
(((13)))

A synchronization program for an information processing device causing a computer to execute a process comprising:
in a case where there is uncreated post-synchronous data that is unable to be provided to the information processing device from an administrative server at a first synchronization request timing at which the administrative server is requested to provide the synchronous data,
synchronizing the post-synchronous data provided from the administrative server after the first synchronization request timing with the synchronous data of the information processing device.
(((14)))

A synchronization program for an administrative server causing a computer to execute a process comprising:
in a case where there is uncreated post-synchronous data that is unable to be provided to an information processing device at a first synchronization request timing at which the information processing device requests provision of the synchronous data,
providing a synchronization necessity notification, which indicates that synchronization processing is necessary after the first synchronization request timing, to the information processing device; and
providing the created post-synchronous data to the information processing device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A synchronization administration system comprising:
one or more first processors configured to:
in a case where there is uncreated post-synchronous data that is unable to be provided to an information processing device from an administrative server at a first synchronization request timing at which the information processing device requests the administrative server to provide synchronous data,
provide a synchronization necessity notification, which indicates that synchronization processing is necessary after the first synchronization request timing, from the administrative server to the information processing device; and
provide the created post-synchronous data from the administrative server to the information processing device.

2. The synchronization administration system according to claim 1, wherein the first processors are configured to:
provide the created post-synchronous data from the administrative server to the information processing device, at a second synchronization request timing at which the information processing device requests provision of the synchronous data, after the first synchronization request timing.

3. The synchronization administration system according to claim 2, wherein the first processors are configured to:
determine the second synchronization request timing in accordance with a usage status of the administrative server or a size of the post-synchronous data.

4. The synchronization administration system according to claim 2, wherein the first processors are configured to:
in a case where the post-synchronous data is unable to be provided from the administrative server to the information processing device at the second synchronization request timing,
provide the created post-synchronous data, at a third synchronization request timing at which the information processing device requests the provision of the synchronous data, after the second synchronization request timing.

5. The synchronization administration system according to claim 3, wherein the first processors are configured to:
in a case where the post-synchronous data is unable to be provided from the administrative server to the information processing device at the second synchronization request timing,
provide the created post-synchronous data, at a third synchronization request timing at which the information processing device requests the provision of the synchronous data, after the second synchronization request timing.

6. The synchronization administration system according to claim 2, wherein the first processors are configured to:
in a case where the post-synchronous data is unable to be provided from the administrative server to the information processing device at the second synchronization request timing,
cause the information processing device to execute polling on the administrative server until a timing at which the administrative server is able to provide the post-synchronous data.

7. The synchronization administration system according to claim 3, wherein the first processors are configured to:
in a case where the post-synchronous data is unable to be provided from the administrative server to the information processing device at the second synchronization request timing,
cause the information processing device to execute polling on the administrative server until a timing at which the administrative server is able to provide the post-synchronous data.

8. The synchronization administration system according to claim 1, further comprising:
one or more second processors configured to:
synchronize the post-synchronous data provided from the administrative server with the synchronous data of the information processing device in a period of time which is preset in accordance with the number of users of the information processing device.

9. The synchronization administration system according to claim 8,
wherein the second processor assigns a priority order for determining an execution order of the synchronization processing in the information processing device to each of a plurality of pieces of the synchronous data in accordance with a type of the synchronous data.

10. The synchronization administration system according to claim 8,
wherein a plurality of synchronization request timings, at which the information processing device requests the provision of the synchronous data, are periodic, and
the second processors are configured to:
in a case where the synchronization necessity notification is provided to the information processing device,
set a periodic interval between the plurality of synchronization request timings shorter than a periodic interval before the synchronization necessity notification is provided.

11. The synchronization administration system according to claim 9,
wherein a plurality of synchronization request timings, at which the information processing device requests the provision of the synchronous data, are periodic, and
the second processors are configured to:
in a case where the synchronization necessity notification is provided to the information processing device,
set a periodic interval between the plurality of synchronization request timings shorter than a periodic interval before the synchronization necessity notification is provided.

12. The synchronization administration system according to claim 1, wherein the first processors are configured to:
in a case where the post-synchronous data is created,
issue, to the information processing device, a notification that the post-synchronous data is able to be provided by using at least one communication method among a communication method using e-mail, a communication method using a mobile communication line, and a communication method using an information processing device different from the information processing device.

13. An administrative server comprising:
one or more first processors configured to:
in a case where there is uncreated post-synchronous data that is unable to be provided to an information processing device at a first synchronization request timing at which the information processing device requests provision of the synchronous data,
provide a synchronization necessity notification, which indicates that synchronization processing is necessary after the first synchronization request timing, to the information processing device; and
provide the created post-synchronous data to the information processing device.

14. (canceled)

15. A non-transitory computer readable medium storing a synchronization administration program causing a computer to execute a process comprising:
in a case where there is uncreated post-synchronous data that is unable to be provided to an information processing device from an administrative server at a first synchronization request timing at which the information processing device requests the administrative server to provide synchronous data,
providing a synchronization necessity notification, which indicates that synchronization processing is necessary after the first synchronization request timing, from the administrative server to the information processing device; and
providing the created post-synchronous data from the administrative server to the information processing device.

16.-17. (canceled)
